(19) United States
(12) Patent Application Publication
(10) Pub. No.: US 2021/0042045 A1
(43) Pub. Date: Feb. 11, 2021

(54) STORAGE SYSTEM AND RESOURCE ALLOCATION CONTROL METHOD

(71) Applicant: HITACHI, LTD., Tokyo (JP)

(72) Inventor: Kohei TATARA, Tokyo (JP)

(73) Assignee: Hitachi, Ltd.

(21) Appl. No.: 16/808,092

(22) Filed: Mar. 3, 2020

(30) Foreign Application Priority Data
Aug. 8, 2019 (JP) 2019-146229

(51) Int. Cl. G06F 3/06

(52) U.S. Cl. CPC G06F 3/0631; G06F 3/067; G06F 3/0605; G06F 3/0653; G06F 3/0659

(57) ABSTRACT

A multi-node storage system includes a plurality of nodes each configuring a node group having a hardware control unit that includes one or more drivers of a resource group of the node and a command control unit that, where the node receives an I/O (Input/Output) command, controls the hardware control unit in an I/O process in accordance with the I/O command. At least one node includes an allocation decision unit. The allocation decision unit decides resource allocation to the hardware control unit and the command control unit for one or more nodes on the basis of the I/O characteristics of the one or more nodes including the node. Of the resource quantity of the resource group of the node, a resource quantity allocated to each of the hardware control unit and the command control unit complies with the decided resource allocation in each of the one or more nodes.

### BACKGROUND

The present invention generally relates to allocation of computation resources in a storage system.

Each general-purpose computer serves as a storage node by executing SDS (Software Defined Storage) software, and as a result, an SDS system as an example of a multi-node storage system is established in some cases.

In the SDS system, the resource quantity of a resource group as plural computation resources, such as a CPU (Central Processing Unit), a storage device, and a port, is distributed to plural functions such as a driver group (one or more drivers) controlling the resource group and I/O processing software processing an I/O command by controlling the driver group.

Regarding allocation of computation resources, technology disclosed in Patent Literature 1 has been known.

Patent Literature 1: WO2016/151821

### SUMMARY

The performance of the SDS system depends on adequacy of resource distribution.

However, it is difficult for a user to decide appropriate resource allocation in consideration of a configuration by a use case, a change in work load, and the like.

For example, as at least a part of the SDS system, a separated configuration or an integrated configuration can be employed. The separated configuration has a configuration in which a server function that executes an application issuing an I/O command is provided in a computer different from a storage node. The integrated configuration has a configuration in which a server function is provided in a storage node. Since an I/O command is issued to a storage function through a network in the separated configuration, the load on a CPU for controlling a communication interface device is larger than that in the integrated configuration.

In addition, for example, if an I/O size (for example, the size of I/O target data per one I/O command) or an I/O pattern (for example, read or write and random or sequential) differs, CPU time to be allocated to one or more drivers controlling a resource group and I/O processing software processing an I/O command by controlling the one or more driver differs.

As described above, it is difficult for a user to decide appropriate resource allocation (for example, resource distribution) to improve the performance of the SDS system.

In addition, such a problem can occur in a multi-node storage system other than the SDS system.

Each of a plurality of nodes configuring a node group includes a hardware control unit that includes one or more drivers of a resource group of the node and a command control unit that, in the case where the node receives an I/O (Input/Output) command, controls the hardware control unit in an I/O process in accordance with the I/O command. At least one node includes an allocation decision unit. The allocation decision unit decides resource allocation to the hardware control unit and the command control unit for one or more nodes on the basis of the I/O characteristics of the one or more nodes including the node. Of the resource quantity of the resource group of the node, a resource quantity allocated to each of the hardware control unit and the command control unit complies with the decided resource allocation in each of the one or more nodes.

Appropriate resource allocation to improve the performance of a multi-node storage system can be automatically decided.

### BRIEF DESCRIPTION OF THE DRAWINGS

FIG. 1 is a diagram for showing an entire configuration of a system according to an embodiment of the present invention;

FIG. 2 is a diagram for showing an example of a physical configuration in a separated configuration;

FIG. 3 is a diagram for showing an example of a logical configuration in an integrated configuration;

FIG. 4 is a diagram for showing an example of a physical configuration in the integrated configuration;

FIG. 5 is a diagram for showing an example of programs and tables stored in a memory of a storage node;

FIG. 6 is a diagram for showing an example of a program and a table held by a management node;

FIG. 7 is a diagram for showing a configuration example of a configuration management table;

FIG. 8 is a diagram for showing a configuration example of an operation mode management table;

FIG. 9 is a diagram for showing a configuration example of an allocation management table;

FIG. 10 is a diagram for showing a configuration example of an I/O statistic management table;

FIG. 11 is a diagram for showing a configuration example of an application mode management table;

FIG. 12 is a diagram for showing a configuration example of an application VM management table;

FIG. 13 is a diagram for showing a flow of a process performed when an allocation decision program receives a configuration change request designating the separated configuration with which application information is associated from management software;

FIG. 14 is a diagram for showing an example of an application designation UI;

FIG. 15 is a diagram for showing a flow of a mode setting process;

FIG. 16 is a diagram for showing a flow of a core mode change process;

FIG. 17 is a diagram for showing a flow of an I/O statistic acquisition process;

FIG. 18 is a diagram for showing a flow of a separation-type scheduler process;

FIG. 19 is a diagram for showing a flow of a migration process;

FIG. 20 is a diagram for showing a flow of a process performed when an application and an integrated configuration are designated for the management software;

FIG. 21 is a diagram for showing an example of an application designation UI;

FIG. 22 is a diagram for showing a flow of an integration-type scheduler process; and

FIG. 23 is a diagram for showing a configuration example of a mode selection support table.

### DETAILED DESCRIPTION

In the following description, an “interface device” may be one or more communication interface devices. The one or more communication interface devices may be one or more communication interface devices (for example, one or more NICs (Network Interface Cards)) of the same kind or two or more communication interface devices (for example, an NIC and an HBA (Host Bus Adapter)) of different kinds.

In addition, in the following description, a “memory” is one or more memory devices as an example of one or more storage devices, and may be typically a main storage device. At least one memory device in the memory may be a volatile memory device or a non-volatile memory device.

In addition, in the following description, a “permanent storage device” may be one or more permanent storage devices as an example of one or more storage devices. The permanent storage device may be typically a non-volatile storage device (for example, an auxiliary storage device), and may be specifically, for example, an HDD (Hard Disk Drive), an SSD (Solid State Drive), an NVMe (Non-Volatile Memory Express) drive, or an SCM (Storage Class Memory).

In addition, in the following description, a “storage device” may be a memory or at least a memory of a permanent storage device.

In addition, in the following description, a “processor” may be one or more processor devices. At least one processor device may be typically a microprocessor device such as a CPU (Central Processing Unit), but may be other types of processor devices such as a GPU (Graphics Processing Unit). At least one processor device may be a single-core processor or a multi-core processor. At least one processor device may be a processor core. At least one processor device may be a processor device in a broad sense such as a hardware circuit (for example, an FPGA (Field-Programmable Gate Array) or an ASIC (Application Specific Integrated Circuit)) that performs a part or all of a process.

In addition, in the following description, information from which an output for an input can be obtained will be explained with an expression of “xxx table” in some cases. However, the information may be data with any structure (for example, structured or unstructured data), or may be a learning model such as a neural network that generates an output for an input. Thus, “xxx table” can be referred to as “xxx information”. In addition, in the following description, the configuration of each table is an example. One table may be divided into two or more tables, or all or a part of two or more tables may be one table.

In addition, in the following description, a process will be explained using a “program” as the subject in some cases. However, since the program is executed by a processor to perform a given process by appropriately using a storage device and/or an interface device, the subject of the process may be a processor (or a device such as a controller having the processor). The program may be installed from a program source into an apparatus such as a computer. The program source may be, for example, a program distribution server or a computer readable (for example, non-transitory) recording medium. In addition, in the following description, two or more programs may be realized as one program, or one program may be realized as two or more programs.

In addition, in the following description, a “storage system” includes a node group (for example, a distribution system) having a multi-node configuration provided with plural storage nodes each of which has a storage device. Each storage node may include one or more RAID (Redundant Array of Independent (or Inexpensive) Disks) groups, but may be typically a general-purpose computer. Each of one or more computers may execute predetermined software to establish the one or more computers as an SDx (Software-Defined anything). As the SDx, for example, an SDS (Software Defined Storage) or an SDDC (Software-defined Datacenter) can be employed. For example, software having a storage function may be executed by each of one or more general-purpose computers to establish a storage system as the SDS. In addition, one storage node may execute a virtual computer as a host computer and a virtual computer as a storage controlling apparatus (typically an apparatus that inputs and outputs data into/from a storage device unit in response to an I/O request) of a storage system.

In addition, in the following description, a “volume” is written as “VOL” in some cases. The “VOL” is an abbreviation of a logic volume, and may be a logical storage device. The VOL may be a real VOL (RVOL) or a virtual VOL (VVOL). The “RVOL” may a VOL on the basis of a physical storage resource (for example, one or more RAID groups) included in a storage system providing the RVOL. The “VVOL” may be, for example, a Thin Provisioning VOL (TPVOL). The TPVOL is configured using plural virtual areas (virtual storage areas), and may be a VOL compliant with the capacity virtualizing technology (typically, Thin Provisioning). A “pool” maybe a storage area configured using plural real areas (real storage areas) on the basis of one or more permanent storage devices (for example, a permanent storage device in a storage node managing the pool, or a permanent storage device in another storage node communicable with the storage node). In the case where a real area is not allocated to a virtual area (a virtual area of the TPVOL) to which the address designated by a received write request belongs, the storage system may allocate the real area to the virtual area (the virtual area into which data is written) from a pool (even if another real area has already been allocated to the virtual area into which data is written, a real area may be newly allocated to the virtual area into which data is written). The storage system may write data to be written accompanying the write request into the allocated real area.

In addition, in the following description, in the case where elements of the same kind are explained without distinguishing them from each other, a common symbol of reference symbols is used. In the case where elements of the same kind are explained by distinguishing them from each other, reference symbols are used in some cases. For example, in the case where storage nodes are explained without particularly distinguishing them from each other, the storage nodes are written as “storage nodes 150”. In the case where storage nodes are explained by distinguishing them from each other, the storage nodes are written as “storage node 150A1” and “storage node 150B1”.

In addition, in the following description, the “I/O quantity” of a storage node may be the quantity of I/O generated when the storage node receives one or more I/O commands. As the “'I/O quantity”, at least one of “the number of inputs and outputs” and an “'I/O size” may be employed. “The number of inputs and outputs” may be the number of I/O commands received by a storage node, or the number of I/O commands issued on the basis of the one or more received I/O commands. The destination of the issued I/O commands may be a storage device in a storage node, or another storage node. The “I/O size” may be the total size of data input and output when a storage node receives one or more I/O commands. The “I/O quantity” may be a write quantity, a read quantity, or a quantity (for example, the total of the write quantity and the read quantity) in accordance with both of the write quantity and the read quantity. The description of the “write quantity” may replace the “I/O” in the description of the “I/O quantity” in this paragraph with “write”. Likewise, the description of the “read quantity” may replace the “I/O” in the description of the “I/O quantity” in this paragraph with “read”.

In addition, in the following description, a “cluster” corresponds to two or more storage nodes. Data to be written generated in a cluster is made redundant (for example, duplicated) to be stored into two or more storage nodes in the cluster. The cluster may include an active storage node 150 and a standby storage node 150 activated instead of the active storage node 150 when the active storage node 150 stops.

Hereinafter, an embodiment will be described in detail.

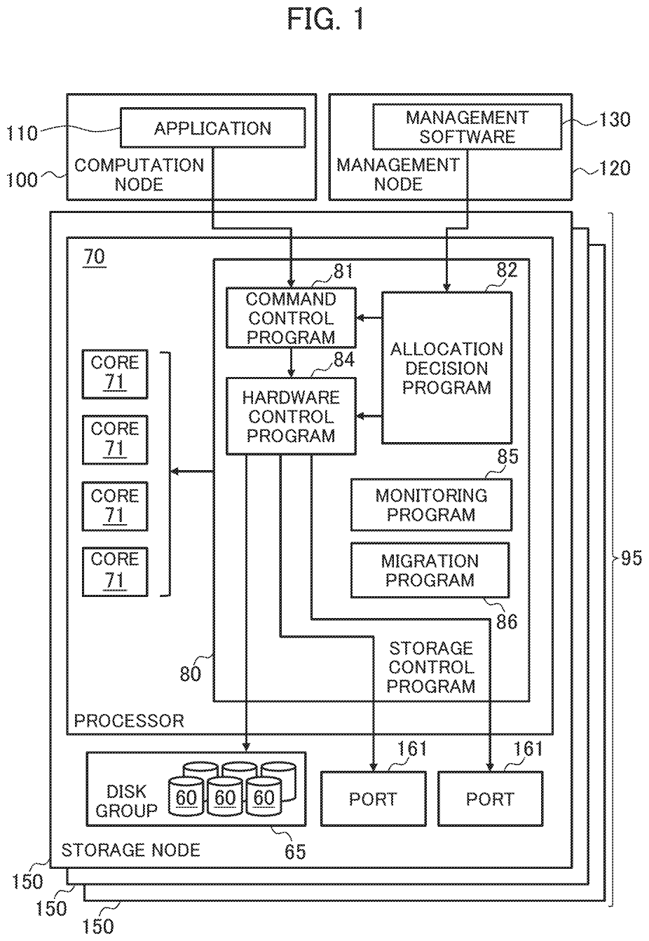

FIG. 1 is a diagram for showing an entire configuration of a system according to the embodiment.

Provided are a computation node 100, a management node 120, and a storage system 95 connected thereto in a communicable manner.

The computation node 100 is a computer that executes an application 110 (application program). The computation node 100 may be a physical computer or a virtual computer (for example, an execution environment such as a virtual machine or a container).

The management node 120 is a computer that executes management software 130. The management node 120 may be a physical computer or a virtual computer. In response to an instruction from an administrator or automatically, the management software 130 can send to an allocation decision program 82, to be described later, a configuration change request with which application information (for example, the types and number of applications) is associated and a migration request with which volume information (for example, the ID of a volume to be migrated) is associated.

The storage system 95 is a node group including plural storage nodes 150. Each storage node 150 is, for example, a computer (for example, a general-purpose computer) that executes predetermined software (for example, SDS software).

In the example of FIG. 1, the computation node 100, the management node 120, and the storage nodes 150 are nodes different from each other. However, one node may serve as two or more nodes among the nodes. For example, at least one of the computation node 100 and the management node 120 maybe included in at least one storage node 150.

Each storage node 150 has a resource group including plural computation resources such as an interface device, a storage device, and a processor 70 connected thereto.

As an example of at least some interface devices, plural ports 161 are provided. The ports 161 are an example of communication interface devices.

As an example of at least some storage devices, a disk group 65 including one or more disks 60 is provided. The disks 60 are an example of storage devices (in particular, permanent storage devices).

An example of at least some processors 70 may be one or more CPUs having one or more CPU cores (hereinafter, referred to as cores) 71. Both of the CPUs and the cores 71 are an example of processor devices.

The processor 70 executes a storage control program 80. The function realized by executing the storage control program 80 may be a storage function. The storage control program 80 may be a set of plural programs including a hardware control program 84, a command control program 81, an allocation decision program 82, a monitoring program 85, and a migration program 86.

The hardware control program 84 includes one or more drivers for controlling the resource group, for example, drivers for the ports 161 and drivers for the disks 60.

In the case where the storage node 150 executing the command control program 81 receives an I/O command, the program 81 controls the hardware control program 84 in an I/O process in accordance with the I/O command. A sequential or random write or read is performed for a volume provided by the storage node 150. In the embodiment, the storage node 150 has a volume, and one or more disks 60 are associated with the volume. The disks 60 may be directly or indirectly (for example, through a pool) allocated to the volume. For example, the storage 150 may have a pool based on one or more disks 60 including the disks 60 provided in the storage node 150 and a volume associated with the pool. An I/O process for the volume is performed for the disk 60 as the basis of an I/O region. Namely, a read process includes a process of reading data from the disks 60 allocated to the volume. A write process includes a process of writing data into the disks 60 allocated to the volume. By duplicating the data to be written in the write process for each storage node 150, one data maybe written into the disks 60 in the storage node 150 and the other data may be written into another storage node 150 (for example, another storage node 150 in the same cluster) through the ports 161.

The allocation decision program 82 may be included in each storage node 150, or may be included in at least one storage node 150 (for example, the master storage node 150) for each cluster. On the basis of I/O characteristics of a target cluster that is an example of one storage node including the storage node 150 executing the allocation decision program 82, the program 82 decides resource allocation (for example, distribution of plural cores 71) to plural programs including the hardware control program 84 and the command control program 81 for the target cluster. For example, the allocation decision program 82 receives a configuration change request with which application information is associated from the management software 130, and decides resource allocation on the basis of I/O characteristics estimated from the application information in response to the configuration change request. In addition, for example, the allocation decision program 82 decides resource allocation on the basis of I/O characteristics in accordance with the I/O statistics of the target cluster. The I/O statistics of the target cluster comply with the I/O statistics of each storage node 150 configuring the target cluster. An example of the function realized by executing the allocation decision program 82 may be an allocation decision unit. In the embodiment, the allocation decision program 82 selects an operation mode conforming to the I/O characteristics of the target cluster from plural operation modes with which plural resource allocations are associated. In the embodiment, the selection of an operation mode is an example of the decision of resource allocation.

The monitoring program 85 monitors I/O statistics on the basis of the write quantity and the read quantity of the storage node 150 executing the program 85. The I/O statistics may be acquired every fixed time. The I/O statistics may be, for example, a sequential write quantity, a random write quantity, a sequential read quantity, and a random read quantity.

The migration program 86 migrates a volume between clusters. The migration of the volume maybe performed in response to a migration request from the management software 130 or may be performed without the request from the management software 130 in accordance with the monitoring result of the I/O statistics.

It should be noted that FIG. 1 relates to the storage system 95 and shows an example of a logical configuration in a separated configuration (a configuration in which a server function executing an application is provided in a computer different from the storage nodes) applied to at least one cluster.

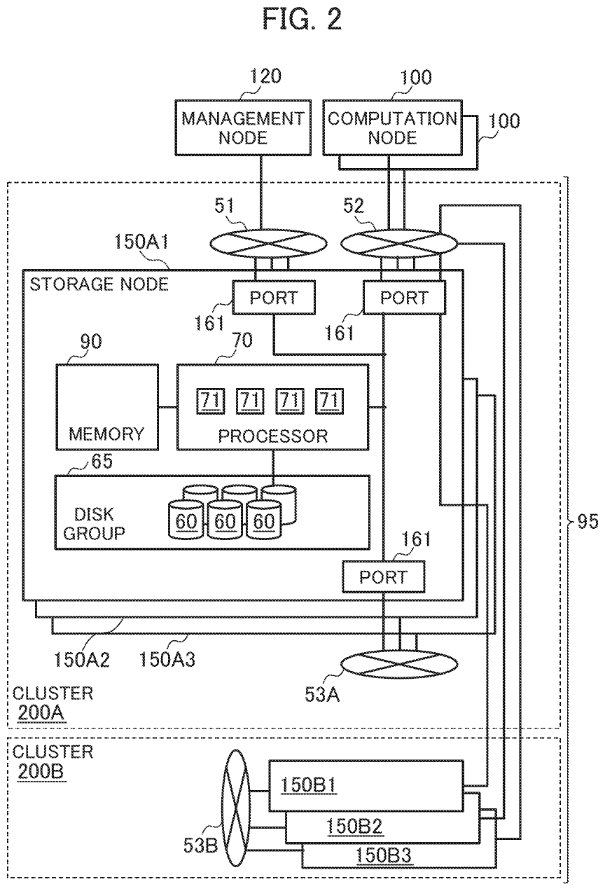

FIG. 2 is a diagram for showing an example of a physical configuration in the separated configuration.

The storage system 95 is configured using plural clusters 200. Each cluster 200 is configured using two or more storage nodes 150. For example, a cluster 200A is configured using storage nodes 150A1 to 150A3, and a cluster 200B is configured using storage node 150B1 to 150B3. Each storage node 150 has a memory 90 in addition to the computation resources described with reference to FIG. 1. The memory 90 is connected to the processor 70.

In each cluster 200, each storage node 150 communicates with the management node 120, the computation node 100, and another storage node 150 through networks. The networks include one or more networks, for example, a first network 51, a second network 52, and a third network 53. The first network 51 is a network used for communications between the storage nodes 150 and the management node 120. The second network 52 is a network used for communications between the storage nodes 150 and the computation node 100 (and storage nodes 150 in another cluster 200). The third network 53 is a so-called internal network used for communications between the storage nodes 150 in the same cluster 200. The third network 53 exists in each cluster 200. For example, there are a network 53A used for communications between the storage nodes 150A and a network 53B used for communications between the storage nodes 150B.

In the configuration exemplified in FIG. 2, for example, the second network 52 may be a WAN (Wide Area Network) or a LAN (Local Area Network), and each of the first network 51 and the third network 53 may be a LAN. At least one of the first network 51, the second network 52, and the third network 53 may be provided in a redundant manner. For example, the first network 51 and the second network 52 maybe a common network without being separated from each other. The connection standard of each of the networks 51 to 53 may be Ethernet (registered trademark), Infiniband (registered trademark) or wireless.

FIG. 1 and FIG. 2 show an example of the separated configuration. According to the separated configuration, the storage node 150 receives an I/O command from the application 110 through the second network 52.

On the other hand, it is conceivable that an integrated configuration (a configuration in which a server function is provided in the storage nodes) is applied to at least one cluster 200.

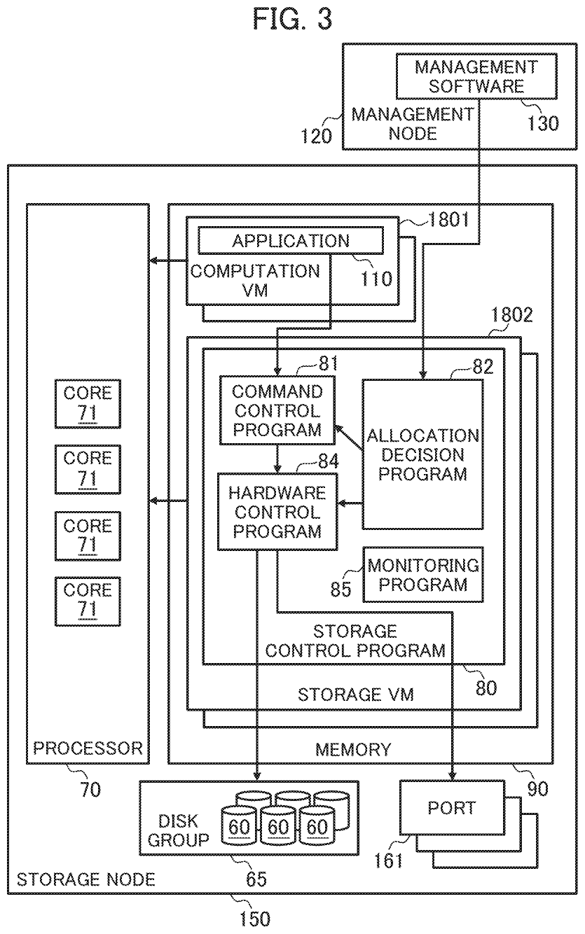

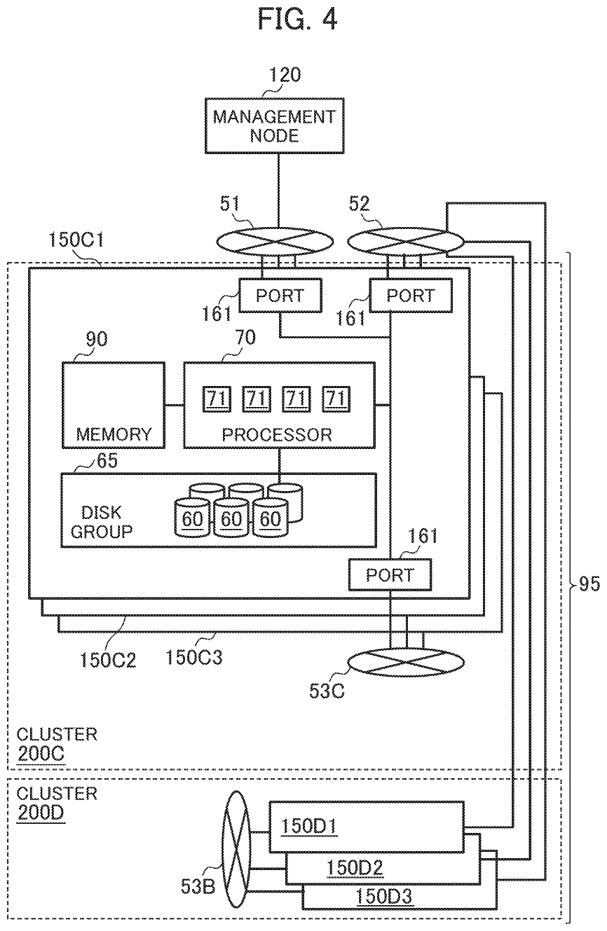

FIG. 3 is a diagram for showing an example of a logical configuration in the integrated configuration. FIG. 4 is a diagram for showing an example of a physical configuration in the integrated configuration.

According to the integrated configuration, reception of an I/O command from the application 110 (namely, reception of an I/O command not through the network) occurs in the storage node 150.

Namely, the application 110 is executed in the storage node 150. Specifically, for example, one or more computation VMs 1801 and one or more storage VMs 1802 are executed by the processor 70 in the storage node 150 as shown in FIG. 3. The computation VM 1801 is a VM (Virtual Machine) executing the application 110, and is an example of the execution environment of the application 110. The storage VM 1802 is a VM executing the storage control program 80, and is an example of the execution environment of the storage control program 80. The execution environment may be an environment other than the VMs, for example, a container.

According to such a logical configuration, the storage VM 1802 receives an I/O command issued from the application 110 in the computation VM 1801 in the storage node 150. Namely, transmission and reception of the I/O command is performed between the application 110 and the storage control program 80 not through the network as described above. Therefore, according to the integrated configuration, there is no computation node connected to the second network 52 as will be exemplified in FIG. 4.

The cluster 200 to which the separated configuration is applied and the cluster 200 to which the integrated configuration is applied may be mixed in the storage system 95. Both of the separated configuration and the integrated configuration are not applied to one cluster 200 at the same time.

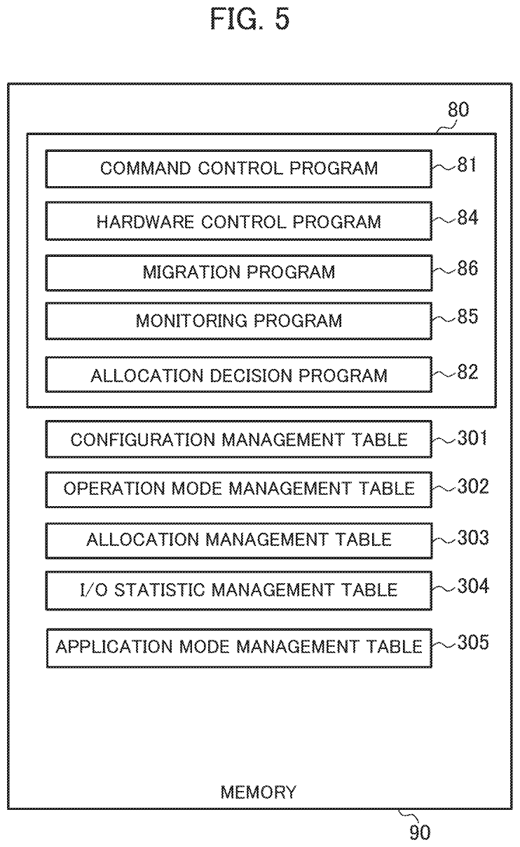

FIG. 5 is a diagram for showing an example of programs and tables stored in the memory 90.

The memory 90 stores the storage control program 80 (namely, the command control program 81, the hardware control program 84, the migration program 86, the monitoring program 85, and the allocation decision program 82). In addition, the memory 90 stores a configuration management table 301 for showing a configuration of the storage system 95 (or the cluster 200 to which the storage node 150 having the memory 90 belongs), an operation mode management table 302 for showing a relation between an operation mode and resource allocation, an allocation management table 303 for showing a status of allocation of the computation resources, an I/O statistic management table 304 for showing acquired I/O statistics, and an application mode management table 305 for showing a relation between an application and an operation mode. At least some of these programs and tables may be stored in at least the disk 60.

The memory 90 exemplified in FIG. 5 maybe the memory 90 of each storage node 150, the memory 90 of the master storage node 150 of each cluster 200, or the memory 90 of any one of the specific storage nodes 150. In addition, at least one table stored in the memory 90 exemplified in FIG. 5 may be saved in the management node 120.

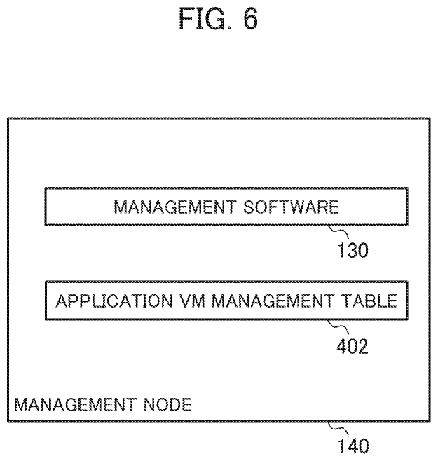

FIG. 6 is a diagram for showing an example of a program and a table held by a management node 140.

The management node 140 holds, in addition to the management software 130, an application VM management table 402 for showing a relation between an application and the number of cores. The application VM management table 402 is present in the case where, for example, a second configuration example is employed for, at least, a part of the storage system 95. The application VM management table 402 has information indicating the number of cores 71 allocated to a VM as information for establishing the integrated configuration suitable for the application 110. When an application is designated from the management software 130, the adequate number of cores 71 is allocated to each of the computation VM 1801 and the storage VM 1802.

Hereinafter, various tables will be described. It should be noted that a random read is denoted as “RR”, a random write is denoted as “RW”, a sequential read is denoted as “SR”, and a sequential write is denoted as “SW” in some cases in the following description.

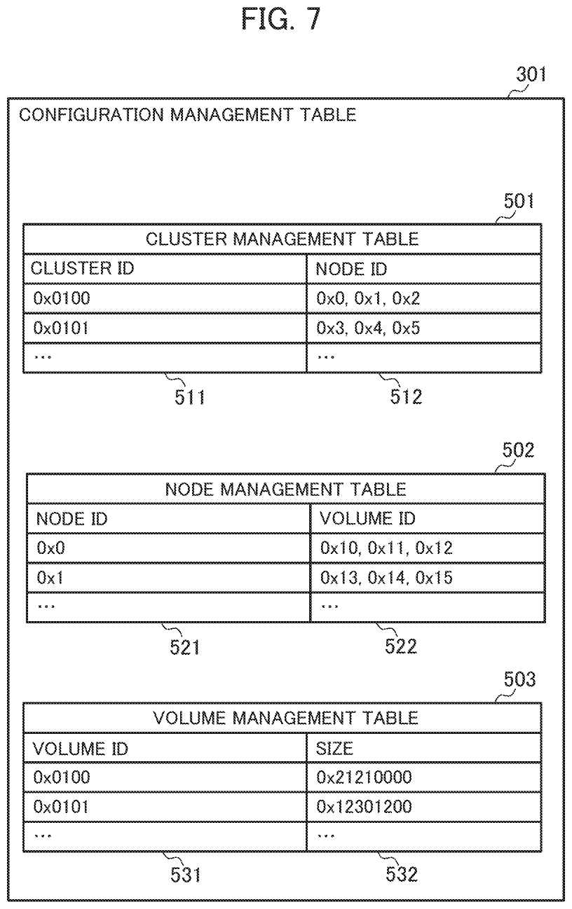

FIG. 7 is a diagram for showing a configuration example of the configuration management table 301.

The configuration management table 301 includes a cluster management table 501, a node management table 502, and a volume management table 503. The configuration management table 301 is held by at least one storage node 150.

The cluster management table 501 shows a configuration of each cluster 200. The cluster management table 501 has, for example, a record for each cluster 200. For each cluster 200, the record includes, for example, information such as a cluster ID 511 indicating the ID of the cluster 200 and a node ID 512 indicating the ID of each storage node 150 belonging to the cluster 200. For each cluster 200, the cluster management table 501 may include information that can distinguish a cluster configuration type applied to the cluster 200. For example, the cluster ID 511 may be a value in accordance with the applied cluster configuration type (for example, the separated configuration or the integrated configuration), or each record may include information indicating the applied cluster configuration type.

The node management table 502 shows a configuration of each storage node 150. The node management table 502 has, for example, a record for each storage node 150. For each storage node 150, the record includes, for example, information such as a node ID 521 indicating the ID of the storage node 150 and a volume ID 522 indicating the ID of each volume.

The volume management table 503 shows a configuration of each volume. The volume management table 503 has, for example, a record for each volume. For each volume, the record includes, for example, information such as a volume ID 531 indicating the ID of the volume and a size 532 indicating the size of the volume. The size 532 may be expressed by, for example, the number of blocks (an example of a unit region) configuring the volume.

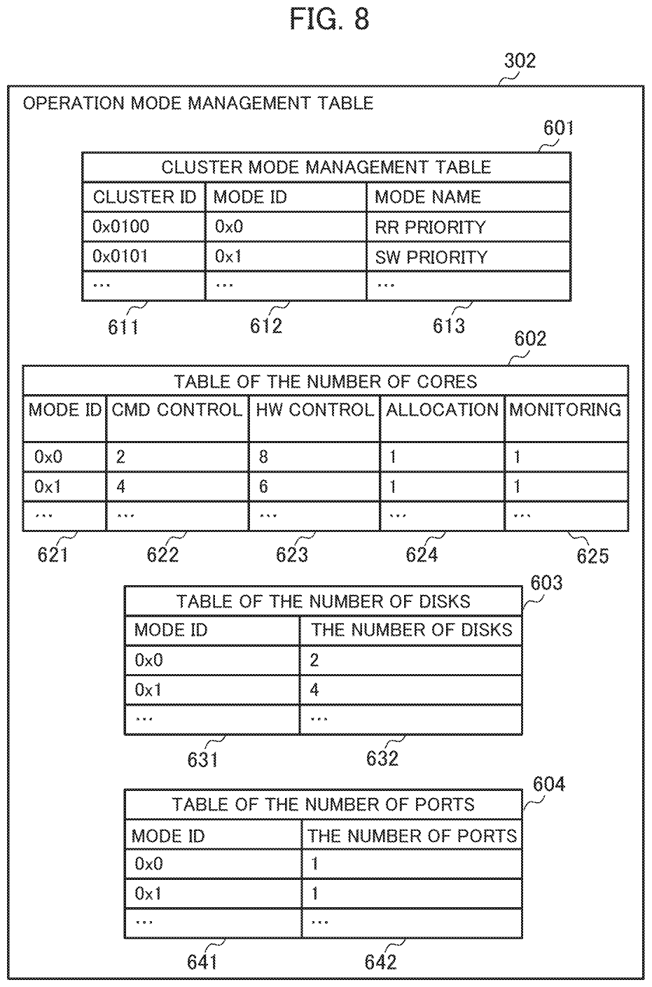

FIG. 8 is a diagram for showing a configuration example of the operation mode management table 302.

The operation mode management table 302 includes a cluster mode management table 601, a table of the number of cores 602, a table of the number of disks 603, and a table of the number of ports 604. The operation mode management table 302 is held by at least one storage node 150.

The cluster mode management table 601 shows a relation between the cluster 200 and an operation mode. The cluster mode management table 601 has, for example, a record for each cluster 200. For each cluster 200, the record includes, for example, information such as a cluster ID 611 indicating the ID of the cluster 200, a mode ID 612 indicating the ID of the operation mode selected for the cluster 200, and a mode name 613 indicating the name (an example of a label) of the selected operation mode. As the operation modes, there are, for example, “read priority” (a read is given top priority), “write priority” (a write is given top priority), “RR priority” (a random read is given top priority), “RW priority” (a random write is given top priority), “SR priority” (a sequential read is given top priority), and “SW priority” (a sequential write is given top priority).

The table of the number of cores 602 shows a relation between an operation mode and the number of cores (allocation of the cores 71 in the resource allocation). The table of the number of cores 602 has, for example, a record for each operation mode. For each operation mode, the record includes, for example, information such as a mode ID 621 indicating the ID of the operation mode, CMD control 622 indicating the number of cores 71 allocated to the command control program 81, HW control 623 indicating the number of cores 71 allocated to the hardware control program 84, CMD control 622 indicating the number of cores 71 allocated to the command control program 81, allocation 624 indicating the number of cores 71 allocated to the allocation decision program 82, and monitoring 625 indicating the number of cores 71 allocated to the monitoring program 85.

The table of the number of disks 603 shows a relation between an operation mode and the number of disks (allocation of the disks 60 in the resource allocation). The table of the number of disks 603 has, for example, a record for each operation mode. For each operation mode, the record includes, for example, information such as a mode ID 631 indicating the ID of the operation mode and the number of disks 632 indicating the number of disks 60 to be allocated. It should be noted that the number of disks 60 to be allocated may be the number of disks 60 as a basis of a region allocated to a volume from a pool in the embodiment. As the number of disks 60 as a basis of the region is larger, I/O operations are performed in parallel, and thus high-speed I/O operations can be expected.

The table of the number of ports 604 shows a relation between an operation mode and the number of ports (allocation of the ports 161 in the resource allocation). The table of the number of ports 604 has, for example, a record for each operation mode. For each operation mode, the record includes, for example, information such as a mode ID 641 indicating the ID of the operation mode and the number of ports 642 indicating the number of ports 161 to be allocated. It should be noted that the number of ports 161 to be allocated may be the number of ports 161 that can be used in communications with another storage node 150 at the time of I/O operations (for example, write operations in particular) of data in the embodiment. As the number of ports 161 is larger, I/O operations are performed in parallel, and thus high-speed I/O operations can be expected.

It should be noted that the pieces of information 622 to 625 in the table of the number of cores 602 in the operation mode management table 302 may be interpreted as the number of computation resources or as the percentage of computation resources. For example, “2” of the information 622 associated with “0x0” of the mode ID 621 may mean that the number of cores 71 allocated to the command control program 81 is “2” or 2/12 (“12” is the sum of the pieces of information 622 to 625) of the total number of cores provided in the storage node 150.

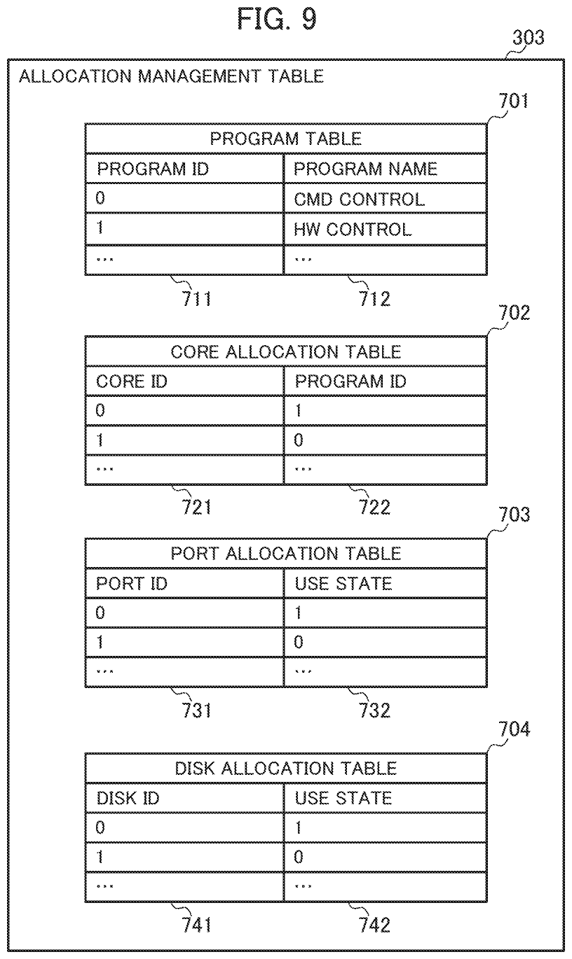

FIG. 9 is a diagram for showing a configuration example of the allocation management table 303.

The allocation management table 303 includes a program table 701, a node core allocation table 702, a port allocation table 703, and a disk allocation table 704. The allocation management table 303 is held by each storage node 150. Hereinafter, one storage node 150 will be exemplified (a “target node 150” in the description of FIG. 9).

The program table 701 shows a name for each program provided in the target node 150. The program table 701 has, for example, a record for each program. For each program, the record includes, for example, information such as a program ID 711 indicating the ID of the program and a program name 712 indicating the name of the program.

The core allocation table 702 shows a relation between a core 71 provided in the target node 150 and a program provided in the target node 150. The core allocation table 702 has, for example, a record for each core 71. For each core 71, the record includes, for example, information such as a core ID 721 indicating the ID of the core 71 and a program ID 722 indicating the ID of the program to which the core 71 is allocated.

The port allocation table 703 shows a use status of a port 161 provided in the target node 150. The port allocation table 703 has, for example, a record for each port 161. For each port 161, the record includes, for example, information such as a port ID 731 indicating the ID of the port 161 and a use state 732 indicating the use state of the port 161. “1” of the use state 732 means being used, and “0” means unused.

The disk allocation table 704 shows a use status of a disk 60 provided in the target node 150. The disk allocation table 704 has, for example, a record for each disk 60. For each disk 60, the record includes, for example, information such as a disk ID 741 indicating the ID of the disk 60 and a use state 742 indicating the use state of the disk 60. “1” of the use state 742 means being used, and “0” means unused.

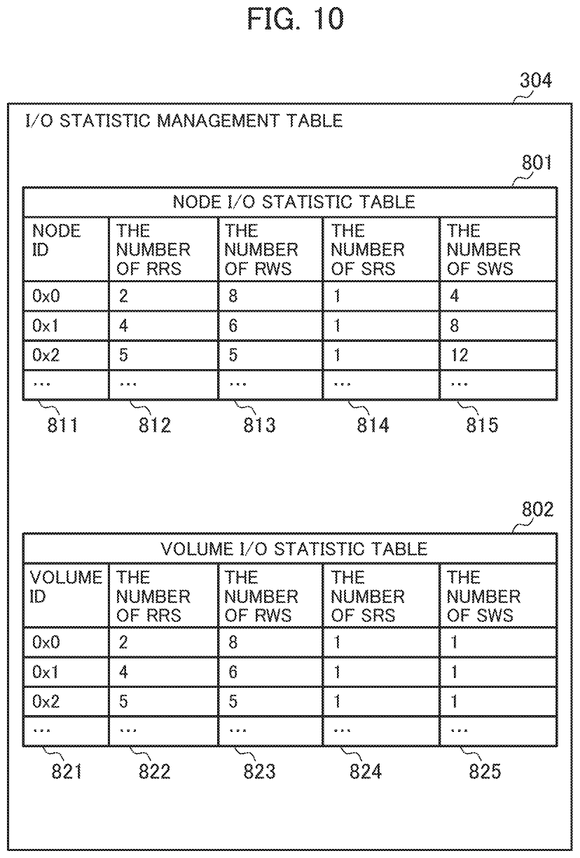

FIG. 10 is a diagram for showing a configuration example of the I/O statistic management table 304.

The I/O statistic management table 304 includes a node I/O statistic table 801 and a volume I/O statistic table 802. The I/O statistic management table 304 is held by at least one storage node 150. It should be noted that the “I/O statistic” is an I/O quantity for each I/O pattern as configured using a combination of a read or a write and sequential or random in the embodiment.

The node I/O statistic table 801 shows the I/O statistics of each storage node 150. The node I/O statistic table 801 has, for example, a record for each storage node 150. For each storage node 150, the record includes, for example, information such as a node ID 811 indicating the ID of the storage node 150, the number of RRs 812 indicating the number of random reads performed by the storage node 150, the number of RWs 813 indicating the number of random writes performed by the storage node 150, the number of SRs 814 indicating the number of sequential reads performed by the storage node 150, and the number of SWs 815 indicating the number of sequential writes performed by the storage node 150. The number of random reads and the number of sequential reads are examples of the read quantity. The number of random writes and the number of sequential writes are examples of the write quantity. The pieces of information 812 to 815 are examples of the I/O statistics of the storage node 150.

The volume I/O statistic table 802 shows the I/O statistics of each volume. The volume I/O statistic table 802 has, for example, a record for each volume. For each volume, the record includes, for example, information such as a volume ID 821 indicating the ID of the volume, the number of RRs 822 indicating the number of random reads performed for the volume, the number of RWs 823 indicating the number of random writes performed for the volume, the number of SRs 824 indicating the number of sequential reads performed for the volume, and the number of SWs 825 indicating the number of sequential writes performed for the volume. The pieces of information 822 to 825 are examples of the I/O statistics of the volume. It should be noted that an example of the I/O characteristics is the I/O statistics.

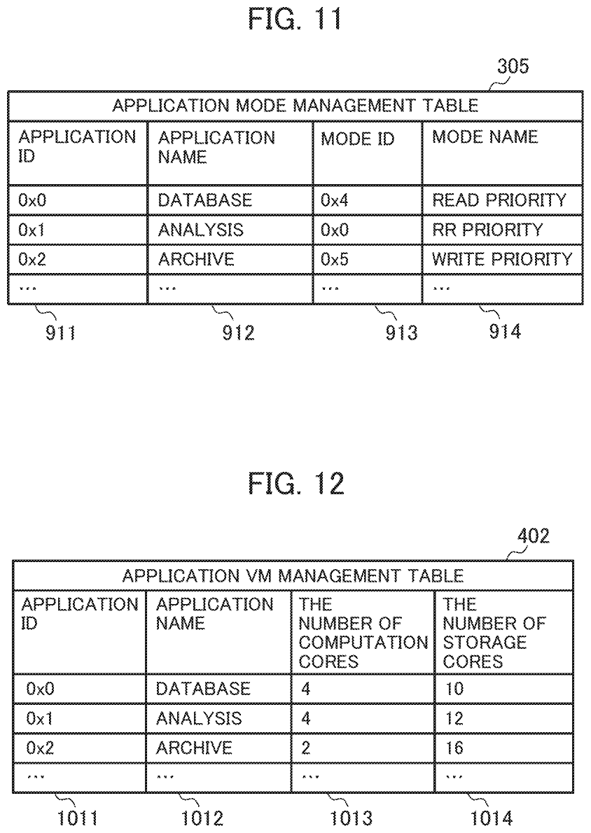

FIG. 11 is a diagram for showing a configuration example of the application mode management table 305.

The application mode management table 305 shows a relation between the application 110 and an operation mode. The application mode management table 305 has, for example, a record for each application 110. For each application 110, the record includes, for example, information such as an application ID 911 indicating the ID of the application 110, an application name 912 indicating the name of the application 110, a mode ID 913 indicating the ID of the operation mode suitable for the application 110, and a mode name 914 indicating the name of the operation mode suitable for the application 11.

FIG. 12 is a diagram for showing a configuration example of the application VM management table 402.

The application VM management table 402 shows a relation between the application 110 and the number of cores 71 allocated to a VM. The application VM management table 402 has, for example, a record for each application 110. For each application 110, the record includes, for example, information such as an application ID 1011 indicating the ID of the application 110, an application name 1012 indicating the name of the application 110, the number of computation cores 1013 indicating the number of cores 71 allocated to the computation VM 1801 executing the application 110, and the number of storage cores 1014 indicating the number of cores 71 allocated to the storage VM 1802 in the storage node 150 including the computation VM 1801 executing the application 110.

Hereinafter, an example of a process performed in the embodiment will be described.

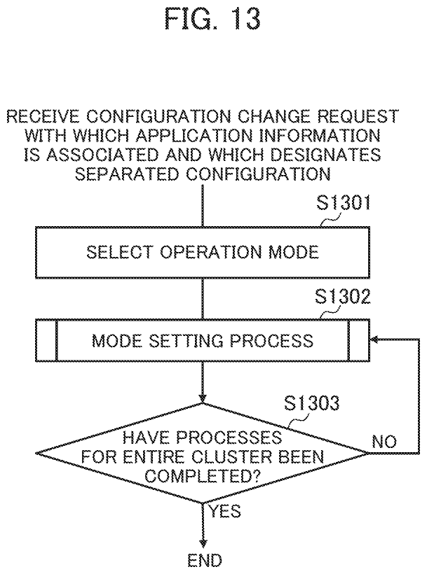

FIG. 13 is a diagram for showing a flow of a process performed when the allocation decision program 82 receives the configuration change request designating the separated configuration with which application information is associated from the management software 130.

The allocation decision program 82 identifies an application name indicated by the application information associated with the received configuration change request, and selects an operation mode corresponding to the identified application name (S1301). Specifically, the allocation decision program 82 identifies the mode ID 913 corresponding to the identified application name from the application mode management table 305.

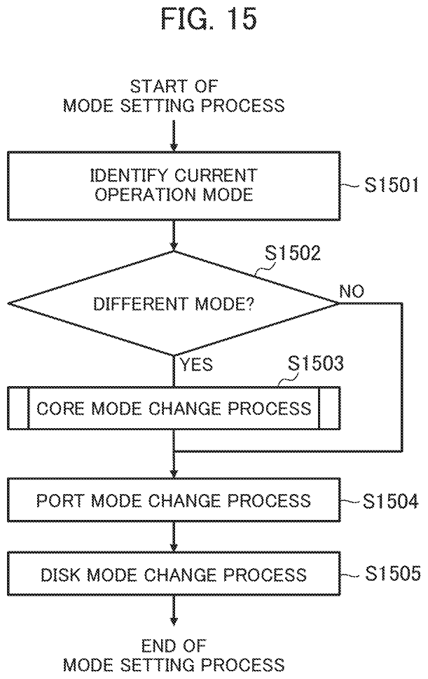

Then, the allocation decision program 82 performs a mode setting process (FIG. 15) (S1302). The mode setting process is a process of setting the selected operation mode to a cluster whose configuration is to be changed according to the configuration change request.

Thereafter, the allocation decision program 82 determines whether or not S1302 has been performed for all the storage nodes 150 belonging to the attentional cluster 200 (the cluster 200 according to the received configuration change request) (S1303). The attentional cluster 200 may be a cluster 200 newly created in response to the configuration change request, or a cluster 200 on which the designated application 110 is running. In addition, requirements (for example, the number of storage nodes 150, the total size of volumes, and the like) of the attentional cluster are associated with the configuration change request, and a newly-created cluster that meets the requirements may be the attentional cluster.

In the case where the determination result of S1303 is false (S1303: No), S1302 is performed for the unprocessed storage node 150.

In the case where the determination result of S1303 is true (S1303: Yes), the process is finished, or another predetermined process is started.

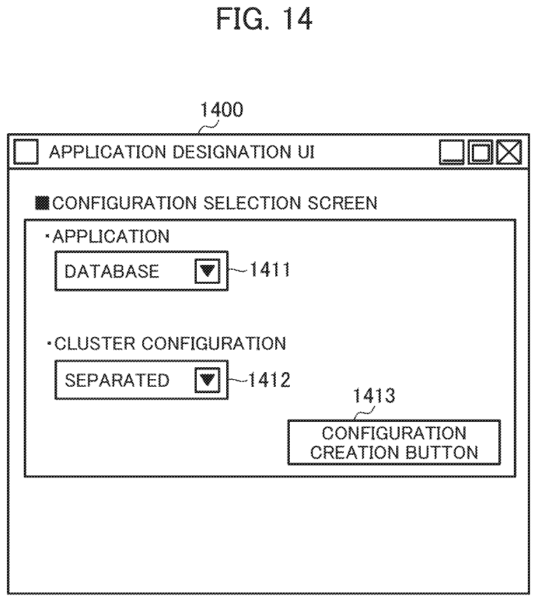

For example, an administrator designates an application and a cluster configuration type using an application designation UI 1400 shown in FIG. 14. The application designation UI 1400 is, for example, a GUI (Graphical User Interface), and includes an application designation UI 1411 that is one or more UIs accepting designation of an application name, a configuration UI 1412 that is one or more UIs accepting designation of a cluster configuration type, and a button 1413 that is an example of a UI accepting designation of configuration creation. The various UIs in the application designation UI 1400 are, for example, GUI components. When the separated configuration is designated using the configuration UI 1412, the application designation UI 1411 is configured as exemplified in FIG. 14. When an application name is designated using the application designation UI 1411 and the button 1413 is pressed, the management software 130 transmits the configuration change request to the storage node 150. The configuration change request is associated with application information indicating the application name designated using the application designation UI 1411, and designates the separated configuration designated using the configuration UI 1412.

FIG. 15 is a diagram for showing a flow of the mode setting process. The mode setting process is performed for each storage node 150 belonging to the attentional cluster.

The allocation decision program 82 designates the operation mode (the mode ID 612 and the mode name 613) corresponding to the cluster ID of the attentional cluster from the cluster mode management table 601 (S1501). It should be noted that in the case where there is no record corresponding to the attentional cluster in the cluster mode management table 601, the record may be added to the cluster mode management table 601.

The allocation decision program 82 determines whether or not a recently-selected operation mode is different from the operation mode identified in S1501 (S1502).

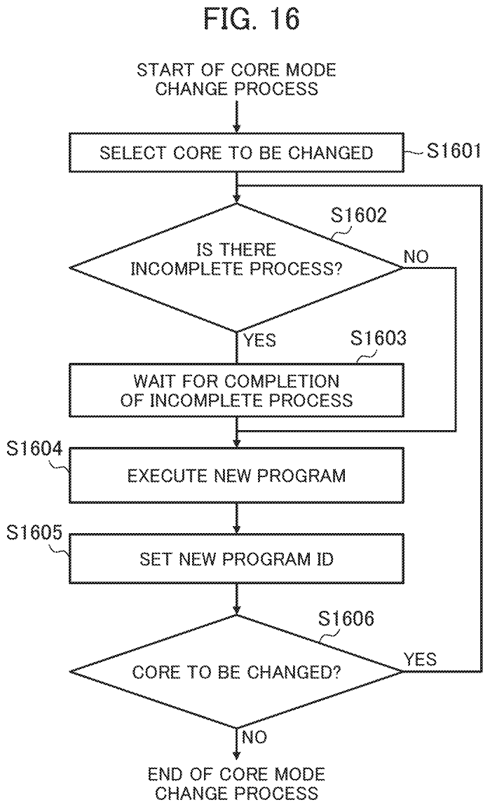

In the case where the determination result of S1502 is true (S1502: Yes), the allocation decision program 82 performs a core mode change process (FIG. 16) (S1503).

After S1503 or in the case where the determination result of S1502 is false (S1502: No), the allocation decision program 82 performs a port mode change process (S1504). In the case where the determination result of S1502 is true, the allocation decision program 82 performs, for example, the following processes. In the case where the determination result of S1502 is false, S1504 may be skipped.

The allocation decision program 82 identifies the number of ports 642 (the number of new ports) corresponding to the recently-selected operation mode from the table of the number of ports 604.

The allocation decision program 82 identifies the number of ports 642 (the number of old ports) corresponding to the operation mode identified in S1501 from the table of the number of ports 604.

The allocation decision program 82 compares the number of new ports with the number of old ports.

If the number of new ports is equal to the number of old ports, S1504 is finished.

If the number of new ports is larger than the number of old ports, the allocation decision program 82 searches the port allocation table 703 for unused ports (ports with “0” of the use state 732) the number of which is obtained by subtracting the number of old ports from the number of new ports, and the use state 732 of each of the located unused ports is updated to “1”.

If the number of new ports is smaller than the number of old ports, the allocation decision program 82 searches the port allocation table 703 for ports in use (ports with “1” of the use state 732) the number of which is obtained by subtracting the number of new ports from the number of old ports, and the use state 732 of each of the located ports in use is updated to “0”.

In addition, the allocation decision program 82 performs a disk mode change process (S1505). In the case where the determination result of S1502 is true, the allocation decision program 82 performs, for example, the following processes. In the case where the determination result of S1502 is false, S1505 may be skipped.

The allocation decision program 82 identifies the number of disks 632 (the number of new disks) corresponding to the recently-selected operation mode from the table of the number of disks 603.

The allocation decision program 82 identifies the number of disks 632 (the number of old disks) corresponding to the operation mode identified in S1501 from the table of the number of disks 603.

The allocation decision program 82 compares the number of new disks with the number of old disks.

If the number of new disks is equal to the number of old disks, S1505 is finished.

If the number of new disks is larger than the number of old disks, the allocation decision program 82 searches the disk allocation table 704 for unused disks (disks with “0” of the use state 742) the number of which is obtained by subtracting the number of old disks from the number of new disks, and the use state 742 of each of the located unused disks is updated to “1”.

If the number of new disks is smaller than the number of old disks, the allocation decision program 82 searches the disk allocation table 704 for disks in use (disks with “1” of the use state 742) the number of which is obtained by subtracting the number of new disks from the number of old disks, and the use state 742 of each of the located disks in use is updated to “0”.

FIG. 16 is a diagram for showing a flow of the core mode change process.

The allocation decision program 82 selects a core to be changed (S1601). In S1601, for example, the allocation decision program 82 performs the following processes.

The allocation decision program 82 identifies the numbers of cores 622 to 625 (“the numbers of new cores 622 to 625” in the description of FIG. 16) that are the pieces of information 622 to 625 corresponding to the recently-selected operation mode from the table of the number of cores 602.

The allocation decision program 82 identifies the numbers of cores 622 to 625 (“the numbers of old cores 622 to 625” in the description of FIG. 16) that are the pieces of information 622 to 625 corresponding to the operation mode identified in S1501.

The allocation decision program 82 compares the number of new cores with the number of old cores for each program.

For the program in which the number of new cores is equal to the number of old cores, the number of cores to be changed is 0.

For the program in which the number of new cores is larger than the number of old cores, or for the program in which the number of new cores is smaller than the number of old cores, the cores the number of which is equal to a difference between the number of new cores and the number of old cores are those to be changed. For example, in the case where the number of old cores is “3” and the number of new cores is “2” for the command control program, the number of cores to be changed is “1”.

S1602 to S1606 are performed for each core to be changed. Hereinafter, one core will be exemplified (an “attentional core” in the description of FIG. 16). The attentional core is unnecessary for a program corresponding to the attentional core due to a surplus of cores, but is necessary for another program due to a lack of cores. In other words, the core is migrated between programs in the core mode change process. Accordingly, even if the I/O characteristics are changed by any one of designation of an application, designation of a cluster configuration, and a change in I/O statistics, the optimum operation mode for the changed I/O characteristics is automatically selected, and the optimum resource distribution (the numbers of cores 622 to 625) for the selected operation mode is maintained.

The allocation decision program 82 determines whether or not there is an incomplete process in the old program (specifically, the program identified on the basis of the program name corresponding to the program 711 matching the program ID 722 corresponding to the attentional core) that is the program operating on the attentional core (S1602). In the case where the determination result of S1602 is true (S1602: Yes), the allocation decision program 82 waits until the incomplete process is finished (S1603).

After S1603 or in the case where the determination result of S1602 is false (S1602: No), the allocation decision program 82 replaces the old program to allocate a new program to the attentional core, and executes the new program on the attentional core (S1604). It should be noted that the “new program”” is any one of programs for which cores lack.

Thereafter, the allocation decision program 82 updates the program ID 722 corresponding to the attentional core from the ID of the old program to the ID of the new program (S1605).

The allocation decision program 82 determines whether or not there is a core to be changed for which the processes subsequent to S1602 have not been performed yet among those selected in S1601 (S1606).

In the case where the determination result of S1606 is true (S1606: Yes), the process returns to S1602. In the case where the determination result of S1606 is false (S1606: No), the core mode change process is finished.

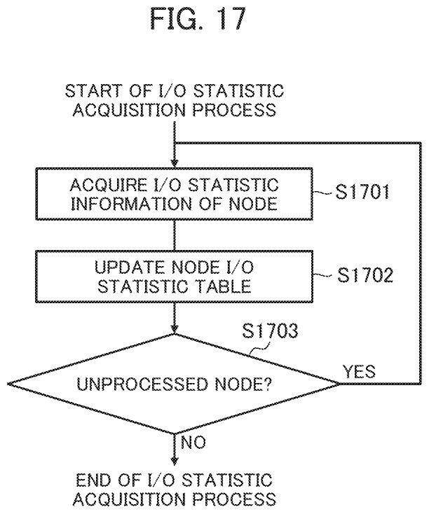

FIG. 17 is a diagram for showing a flow of an I/O statistic acquisition process.

For example, in each storage node 150, the monitoring program 85 regularly acquires the I/O statistics (for example, the number of RRs, the number of RWs, the number of SRs, and the number of SWs) for each volume and the I/O statistics of the storage node 150. The I/O statistics of the storage node 150 include, for example, plural kinds of I/O quantities such as the number of RRs, the number of RWs, the number of SRs, and the number of SWs, and each I/O quantity may be the total, average, maximum value, minimum value, or the like of the I/O quantities of all the volumes provided in the storage node 150.

For example, the master storage node 150 (hereinafter, referred to as a master node 150) exists in each cluster 200, and the I/O statistic acquisition process is executed by the monitoring program 85 of the master node 150 (hereinafter, referred to as a master monitoring program 85). Hereinafter, one cluster 200 will be exemplified (an “attentional cluster 200” in the description of FIG. 17).

From a storage node 150 belonging to the attentional cluster 200, the master monitoring program 85 acquires I/O statistic information indicating the I/O statistics for each volume and the I/O statistics of the storage node 150 (S1701). The master monitoring program 85 registers the pieces of information 812 to 815 (the records in the node I/O statistic table 801) corresponding to the storage node 150 on the basis of the I/O statistic information of the storage node 150 (S1702).

The master monitoring program 85 refers to the cluster management table 501 to determine whether or not there is a storage node 150 for which S1701 and S1702 have not been performed within a fixed period of time in the attentional cluster 200 (S1703).

In the case where the determination result of S1703 is true (S1703: Yes), the process returns to S1701. In the case where the determination result of S1703 is false (S1703: No), the acquisition of the I/O statistics in the attentional cluster for the fixed period of time is finished.

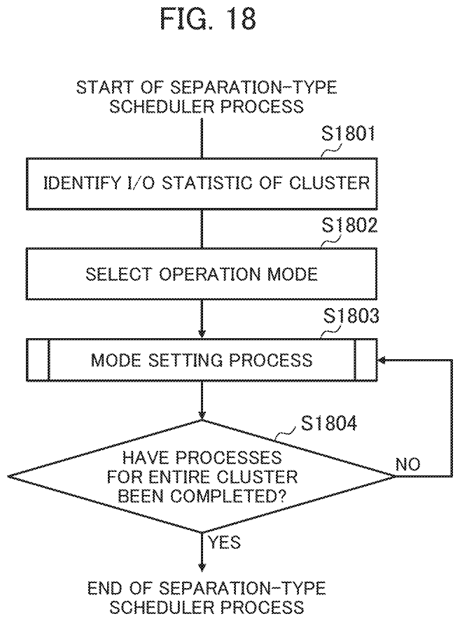

FIG. 18 is a diagram for showing a flow of a separation-type scheduler process.

The separation-type scheduler process is a process for a cluster to which the separated configuration is applied. The separation-type scheduler process includes selecting an operation mode suitable for the I/O statistics of the cluster and performing the resource allocation corresponding to the operation mode. For example, the separation-type scheduler process is regularly or irregularly performed by the allocation decision program 82 of the master node 150. Hereinafter, one cluster 200 will be exemplified (an “attentional cluster 200” in the description of FIG. 18).

The allocation decision program 82 refers to the node I/O statistic table 801 to identify the I/O statistics of the attentional cluster 200 from the I/O statistics of each storage node 150 belonging to the attentional cluster 200 (S1801). The I/O statistics of the attentional cluster 200 include, for example, plural kinds of I/O quantities such as the number of RRs, the number of RWs, the number of SRs, and the number of SWs, and each I/O quantity may be the total, average, maximum value, minimum value, or the like of the I/O quantities of all the storage nodes 150 provided in the attentional cluster 200.

The allocation decision program 82 selects an operation mode conforming to the I/O statistics of the attentional cluster 200 from plural operation modes (S1802). For example, the allocation decision program 82 determines a larger number between the numbers of writes and reads or the largest number among the numbers of RRs, RWs, SRs, and SWs from the I/O statistics of the attentional cluster 200. If the number of reads is larger, a determination result of “read priority” can be obtained, if the number of writes is larger, a determination result of “write priority” can be obtained, and if the number of RRs reads is the largest, a determination result of “RR priority” can be obtained. The allocation decision program 82 identifies the application mode closest to such a determination result from the application mode management table 305.

The allocation decision program 82 performs the mode setting process (FIG. 15). In the mode setting process, the recently-selected operation mode is the operation mode selected in S1802.

The allocation decision program 82 determines whether or not S1803 has been performed for all the storage nodes 150 belonging to the attentional cluster 200 (S1804).

In the case where the determination result of S1804 is false (S1804: No), S1803 is performed for the unprocessed storage node 150. In the case where the determination result of S1804 is true (S1804: Yes), the separation-type scheduler process is finished.

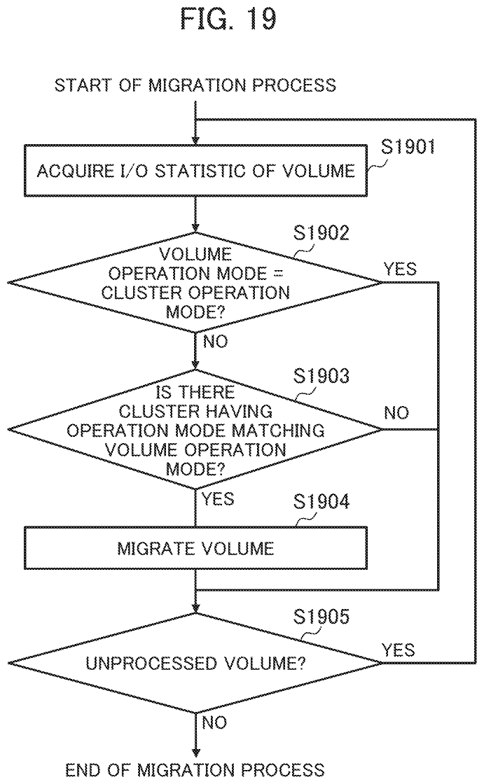

FIG. 19 is a diagram for showing a flow of a migration process.

The migration process is performed by the migration program 86. In the description of FIG. 19, the storage node 150 executing the migration program 86 is referred to as an “attentional node 150” and the cluster 200 to which the attentional node 150 belongs is referred to as an “attentional cluster 200”. In addition, in the description of FIG. 19, the operation mode set to the cluster 200 (each storage node 150 belonging to the cluster 200) is referred to as a “cluster operation mode”.

The migration program 86 selects one of unprocessed volumes from the attentional node 150, and identifies the I/O statistics of the selected unprocessed volume from the volume I/O statistic table 802 (S1901). The “unprocessed volume” is a volume that has not been a target for the processes subsequent to S1901 yet. The unprocessed volume selected in S1901 is referred to as a “selected volume” in the description of FIG. 19.

The migration program 86 selects an operation mode conforming to the I/O statistics identified in S1901 using, for example, the method similar to S1802 of FIG. 18, and determines whether or not the selected operation mode (hereinafter, referred to as a volume operation mode) matches the current cluster operation mode of the attentional cluster 200 (S1902). In the case where the determination result of S1902 is true (S1902: Yes), the process proceeds to S1905.

In the case where the determination result of S1902 is false (S1902: No), the migration program 86 determines whether or not there is a conforming cluster 200 that is a cluster 200 to which the cluster operation mode matching the volume operation mode is set on the basis of the cluster mode management table 601 in the attentional node 150 (or the master node 150 of the attentional cluster 200) (S1903). In the case where the determination result of S1903 is false (S1903: No), the process proceeds to S1905.

In the case where the determination result of S1903 is true (S1903: Yes), the migration program 86 migrates the selected volume to the storage node 150 in the conforming cluster 200 (S1904). The storage node 150 to which the selected volume is migrated may be a storage node 150 identified to have free space in which a volume having the same size as the selected volume can be created. Such a storage node 150 may be identified on the basis of, for example, information (not shown) managing free space for each storage node 150.

The migration program 86 determines whether or not there is an unprocessed volume in the attentional node 150 (S1905).

In the case where the determination result of S1905 is true (S1905: Yes), S1905 is performed for the unprocessed storage node 150. In the case where the determination result of S1905 is false (S1905: No), the migration process is finished.

According to the description of FIG. 19, the migration process may be regularly or irregularly performed on the basis of the volume I/O statistic table 802 in the attentional node 150. Instead of or in addition to it, the migration process may be performed by the migration program 86 in the master node 150 of the attentional cluster 200, or may be performed by the management software 130. In the latter case, for example, the management software 130 may collect, at least, the I/O statistic management table 304 among the tables 301 to 305 of each storage node 150 in the storage system 95. In addition, the management software 130 may perform S1901 to S1903. In the case where the determination result of S1903 is true, the management software 130 may transmit, to at least one of the migration program 86 of the migration-source storage node 150 and the migration program 86 of the migration-destination storage node 150, a migration request for migrating the selected volume from the migration-source storage node 150 to the migration-destination storage node 150.

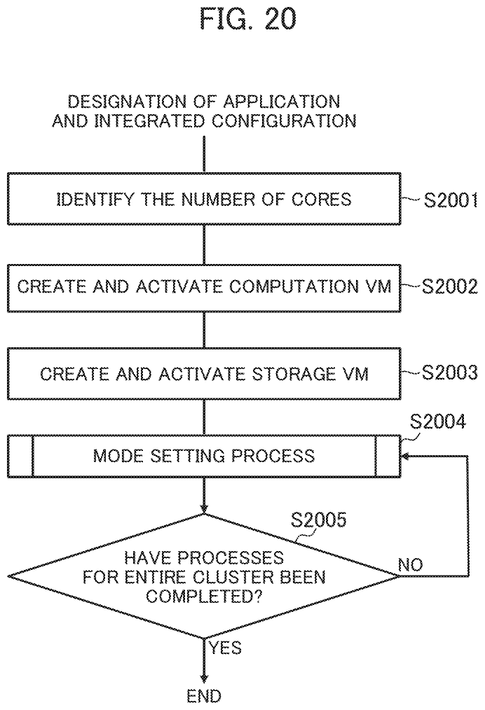

FIG. 20 is a diagram for showing a flow of a process performed when the application and the integrated configuration are designated for the management software 130.

The management software 130 identifies the number of computation cores and the number of storage cores corresponding to the designated application from the application VM management table 402 (S2001).

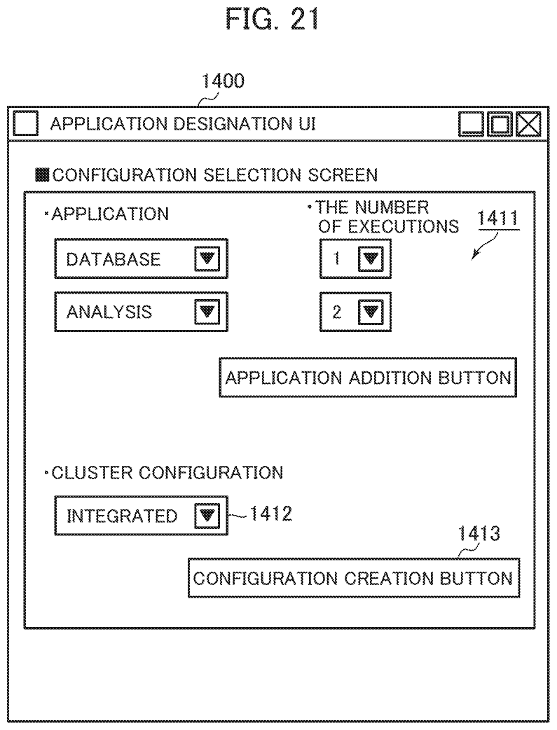

It should be noted that the designation of the application and the integrated configuration is performed, for example, as follows. Namely, the integrated configuration is designated on the configuration UI 1412 (see FIG. 21) of the application designation UI 1400. Then, the application designation UI 1411 is configured as exemplified in FIG. 21. Namely, one or more UIs accepting the designation of the number of executions for one or more applications are expanded. For example, when an application addition button is pressed, a set of a UI accepting the designation of an application and a UI accepting the number of executions of the application is added to the application designation UI 1411. The administrator designates the application and the number of executions on the application designation UI 1411.

As described above, in the case where the integrated configuration is designated, there is a case that one or more instances are designated for one application, or plural applications are designated. In the case where N (N is a natural number) instance(s) is (are) designated for one application, the number of computation cores identified in S2001 may be the product of the number of computation cores corresponding to the application and N, and the number of storage cores to be identified may be the product of the number of storage cores corresponding to the application and N. In the case where plural applications are designated, the number of computation cores to be identified may be the sum of the numbers of computation cores 1013 corresponding to the plural applications, and the number of storage cores to be identified may be the sum of the numbers of storage cores 1014 corresponding to the plural applications.

Hereinafter, the cluster 200 having the cores 71 the number (the number of computation cores and the number of storage cores) of which is identified in S2001 is referred to as an “attentional cluster 200” in the description of FIG. 20. The attentional cluster 200 may be a cluster 200 (for example, a cluster 200 configured using two or more storage nodes 150 that do not belong to any clusters 200) newly created by the management software 130 between S2001 and S2002, or an existing cluster 200 in which the number of unused cores is equal to or larger than the number of cores identified in S2001 and to which the integrated configuration is applied. The cluster configuration type applied to the cluster 200 may be identified from, for example, the cluster management table 501.

The management software 130 instructs the attentional cluster 200 (for example, the master node 150 of the attentional cluster 200) to create and activate a computation VM 1801 to which the number of computation cores identified in S2001 is allocated (S2002). For example, the application information (for example, the designated application and the number of executions) may be associated with the instruction. In response to the instruction, one or more computation VMs 1801 are created and activated in at least one storage node 150 belonging to the attentional cluster 200 by, for example, the allocation decision program 82. The number of computation VMs 1801 to be created may depend on the number of designated applications. For example, one or more instances of the same application may be executed in one computation VM 1801, but it is not necessary to execute a different application. The computation VM 1801 may be created for each application.

The management software 130 instructs the attentional cluster 200 (for example, the master node 150 of the attentional cluster 200) to create and activate a storage VM 1802 to which the number of storage cores identified in S2001 is allocated (S2003). In response to the instruction, one or more storage VMs 1802 are created and activated in at least one storage node 150 belonging to the attentional cluster 200 by, for example, the allocation decision program 82.

In S2002 or S2003, the allocation decision program 82 selects an operation mode conforming to the designated application. In the description of FIG. 20, the number of attentional clusters 200 is one. Therefore, in the case where plural applications to which different operation modes conform are designated, the operation mode to be set to the attentional cluster 200 may be selected on the basis of at least one of the followings.

The priority of each of one or more designated applications

The designated number of executions for each of one or more designated applications

The number of applications to which the same operation mode conforms

After the operation mode is selected, the allocation decision program 82 performs the mode setting process (FIG. 15) (S2004).

The allocation decision program 82 determines whether or not S2004 has been performed for all the storage nodes 150 belonging to the attentional cluster 200 (S2005).

In the case where the determination result of S2005 is false (S2005: No), S2004 is performed for the unprocessed storage node 150.

In the case where the determination result of S2005 is true (S2005: Yes), the process is finished, or another predetermined process is started.

It should be noted that the number of attentional clusters 200 may be plural. For example, the cluster 200 may be prepared for each operation mode, and each of one or more designated applications may be executed by the cluster in accordance with the operation mode suitable for the application.

In addition, in the mode setting process in the case where the integrated configuration is designated, the number of cores 71 allocated to each program in the storage control program 80 executed by the storage VM 1802 does not occasionally match the number of cores identified from the table of the number of cores 602 using the selected operation mode as a key. Because the number of cores allocated to the storage VM 1802 is based. In other words, the number of cores is distributed to each program in the storage control program 80 executed by the storage VM 1802 on the basis of the number of cores allocated to the storage VM 1802 and the numbers of cores 622 to 625 corresponding to the selected operation mode. For example, in the case where the number of cores allocated to the storage VM 1802 is 60, the total of the numbers of cores 622 to 625 corresponding to the selected operation mode is 12, and the number of cores 622 corresponding to the selected operation mode is “2”, the number of cores 71 allocated to the command control program 81 may be 10 (=60×2/12) or a number smaller than 10 in accordance with resource distribution indicated by the numbers of cores 622 to 625.

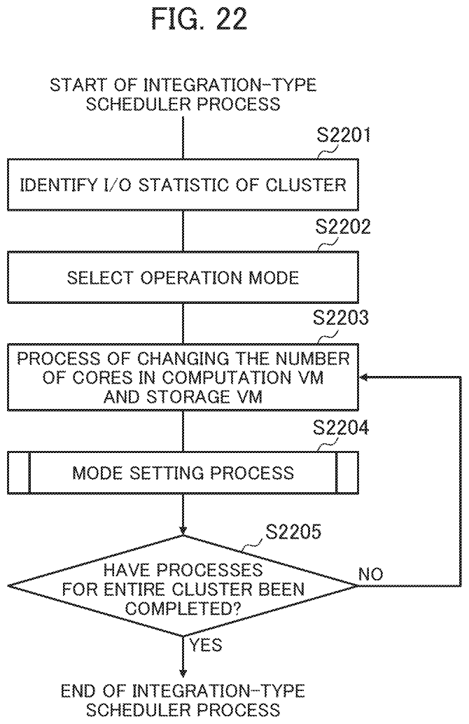

FIG. 22 is a diagram for showing a flow of an integration-type scheduler process.

The integration-type scheduler process is a process for the cluster to which the integrated configuration is applied. The integration-type scheduler process includes selecting an operation mode suitable for the I/O statistics of the cluster and performing the resource allocation corresponding to the operation mode. For example, the integration-type scheduler process is regularly or irregularly performed by the allocation decision program 82 of the master node 150. Hereinafter, one cluster 200 will be exemplified (an “attentional cluster 200” in the description of FIG. 22).

The allocation decision program 82 identifies the I/O statistics of the attentional cluster 200 (S2201), and an operation mode conforming to the I/O statistics is selected (S2202). S2201 may be the same as S1801, and S2202 may be the same as S1802.

A process of changing the numbers of cores in the computation VM 1801 and the storage VM 1802 is performed (S2203). Specifically, in the case where the operation mode selected in S2202 is different from the current operation mode of the attentional cluster 200, for example, the following process is performed. The allocation decision program 82 identifies the application ID corresponding to the operation mode selected in S2202 from the application mode management table 305, and notifies the management software 130 of the identified application ID. The management software 130 identifies the number of cores (the number of computation cores and the number of storage cores) corresponding to the notified application ID from the application VM management table 402, and transmits a change instruction designating the identified number of cores to the attentional cluster 200 (for example, the allocation decision program 82 from which the application ID is notified). In response to the change instruction, for example, the allocation decision program 82 performs the followings.

In the case where the number of cores allocated to the existing computation VM 1801 is different from the number of computation cores designated by the change instruction, the number of cores 71 allocated to the existing computation VM 1801 is changed to the designated number of computation cores.

In the case where the number of cores allocated to the existing storage VM 1802 is different from the number of storage cores designated by the change instruction, the number of cores 71 allocated to the existing storage VM 1802 is changed to the designated number of storage cores.

The allocation decision program 82 performs the mode setting process (FIG. 15). In the mode setting process, the recently-selected operation mode is the operation mode selected in S2202.

The allocation decision program 82 determines whether or not S2203 and S2204 have been performed for all the storage nodes 150 belonging to the attentional cluster 200 (S2205).

In the case where the determination result of S2205 is false (S2205: No), S2203 is performed for the unprocessed storage node 150.

In the case where the determination result of S2205 is true (S2205: Yes), the integration-type scheduler process is finished.

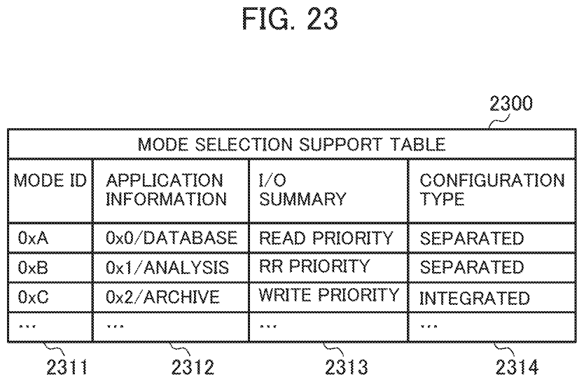

The above is the description of the embodiment. It should be noted that instead of or in addition to the application mode management table 305, a mode selection support table 2300 exemplified in FIG. 23 may be stored in the memory 90 of at least one storage node 150. The mode selection support table 2300 may have, for example, a record for each operation mode. The record may include information such as a mode ID 2311 indicating the ID of an operation mode, application information 2312 indicating an application ID and an application name conforming to the operation mode, an I/O summary 2313 indicating an I/O characteristic summary conforming to the operation mode, and a configuration type 2314 indicating a cluster configuration type conforming to the operation mode. The allocation decision program 82 can select an operation mode corresponding to the designated application, the designated cluster configuration type, and the I/O statistics acquired for the cluster from the mode selection support table 2300.

The above description can be summarized, for example, as follows.

For example, in the storage system 95 as an example of a multi-node storage system established by executing SDS software with each computer, the hardware control program 84 (an example of a hardware control unit) includes one or more drivers of a resource group. The hardware control program 84 can include some programs in an OS (Operating System) of the storage node 150. Such a hardware control program 84 is generally provided by a vendor different from that of the command control program 81 (an example of a command control unit). In the storage node 150, a resource quantity suitable for each of plural programs such as the command control program 81 and the hardware control program 84 controlled by the command control program 81 depends on the status of the storage node 150.

Accordingly, at least one storage node 150 (for example, the master node 150) of the storage system 95 has the allocation decision program 82 (an example of an allocation decision unit). On the basis of the I/O characteristics of one or more storage nodes 150 including the storage node 150, the allocation decision program 82 decides the resource allocation to plural programs including the hardware control program 84 and the command control program 81 for the one or more storage nodes 150. In each of the one or more storage nodes 150, a resource quantity allocated to each of plural programs including the hardware control program 84 and the command control program 81 in the resource quantity of the resource group of the storage node 150 complies with the decided resource allocation. Thereby, the resource allocation suitable for improving the performance of the storage system 95 can be automatically decided. It should be noted that regarding at least one kind of computation resource for each node 15, the “resource quantity” may be at least one of the number of computation resources or a time length where the computation resource can be used. In addition, the “resource allocation” may be distribution of the resource quantity as a standard.

Each of plural storage nodes 150 may be one of constitutional elements of plural clusters 200. Each cluster 200 may be configured using two or more storage nodes 150. In addition, the “one or more storage nodes 150” in the previous paragraph may be the target cluster 200 that is one of plural clusters 200. Accordingly, the resource allocation can be realized on a cluster basis, and thus the performance suitable for the I/O characteristics of each cluster 200 can be expected.

The I/O characteristics of the target cluster 200 may be based on the application information that is information input through the application designation UI 1400 (an example of a user interface). The application information may be information indicating one or more applications issuing an I/O command to the target cluster 200. Accordingly, the resource allocation suitable for the I/O characteristics expected for the target cluster 200 before activating the target cluster 200 can be realized. Therefore, improvement of the performance of the target cluster 200 can be expected.

Each storage node 150 may be provided with a monitoring program 85 (an example of a monitoring unit) for monitoring I/O statistics that are statistics on the basis of the write quantity and the read quantity of the storage node 150. The I/O characteristics of the target cluster 200 may include the I/O statistics of the target cluster 200 identified on the basis of the I/O statistics of each of two or more storage nodes 150 configuring the target cluster 200. Every time resource allocation is decided on the basis of the I/O characteristics of the target cluster 200, if the decided resource allocation differs from recent resource allocation of the target cluster 200 in each of two or more storage nodes belonging to the target cluster 200, the resource quantity allocated to each of plural programs including the hardware control program 84 and the command control program 81 may be changed in accordance with the decided resource allocation. Accordingly, the resource allocation suitable for the I/O statistics of the target cluster 200 can be maintained, and thus it can be expected to maintain the performance of the target cluster 200.

The I/O characteristics of the target cluster 200 may include a cluster configuration type in accordance with whether or not the target cluster 200 receives an I/O command issued from an application through a network. Accordingly, the resource allocation also suitable for the cluster configuration type can be expected.

Each of plural clusters 200 may have one or more volumes. In the case where the target cluster 200 has a target volume that is a volume having I/O characteristics that do not conform to the I/O characteristics of the target cluster 200, the target volume may be migrated to the cluster 200 having I/O characteristics conforming to the I/O characteristics of the target volume. Accordingly, the number of volumes having I/O characteristics conforming to the I/O characteristics of the cluster 200 is relatively increased in each cluster 200. As a result, improvement of the performance or each cluster 200 can be expected.

The decision on the resource allocation maybe selection of the operation mode conforming to the I/O characteristics of one or more storage nodes among those related to inputs and outputs. For each of plural operation modes, the resource allocation in accordance with the operation mode may be associated with the operation mode. For each of one or more storage nodes 150 (for example, each cluster 200), the decided resource allocation may be the resource allocation associated with the selected operation mode. Since the resource allocation is decided through the operation mode as described above, it can be expected to easily decide the optimum resource allocation.

The embodiment of the present invention has been described above. However, it is obvious that the present invention is not limited to the embodiment, and can be variously changed without departing from the gist thereof. For example, it is not necessary for the storage system 95 to have the cluster 200.

What is claimed is:

1. A storage system comprising a node group including a plurality of storage nodes,
wherein each of the plurality of storage nodes includes;
a resource group as a plurality of computation resources including one or more processor devices, one or more storage devices, and one or more communication interface devices;
a hardware control unit that includes one or more drivers controlling the one or more permanent storage devices and the one or more communication interface devices; and
a command control unit that, in the case where the storage node receives an I/O (Input/Output) command, controls the hardware control unit in an I/O process in accordance with the I/O command,
wherein at least one storage node of the node group includes an allocation decision unit that decides resource allocation to the hardware control unit and the command control unit for one or more storage nodes on the basis of the I/O characteristics of the one or more storage nodes including the storage node, and
wherein of the resource quantity of the resource group of the storage node, a resource quantity allocated to each of the hardware control unit and the command control unit complies with the decided resource allocation in each of the one or more storage nodes.

2. The storage system according to claim 1,
wherein each of the plurality of storage nodes is one constitutional element among a plurality of clusters,
wherein each of the plurality of clusters is configured using two or more storage nodes, and
the one or more storage nodes are some target clusters among the plurality of clusters.

3. The storage system according to claim 2,
wherein the I/O characteristics of the target cluster are based on application information that is information input through a user interface, and
wherein the application information is information that indicates one or more applications issuing an I/O command to the target cluster.

4. The storage system according to claim 3,
wherein each of the plurality of storage nodes includes a monitoring unit monitoring I/O statistics that are statistics on the basis of the write quantity and the read quantity of the storage node,
wherein the I/O characteristics of the target cluster include the I/O statistics of the target cluster identified on the basis of the I/O statistics of each of two or more storage nodes configuring the target cluster, and
wherein every time resource allocation is decided on the basis of the I/O characteristics of the target cluster, if the decided resource allocation differs from recent resource allocation of the target cluster in each of the two or more storage nodes, the resource quantity allocated to each of the hardware control unit and the command control unit is changed in accordance with the decided resource allocation.

5. The storage system according to claim 4,
wherein the I/O characteristics of the target cluster include a cluster configuration type compliant with whether or not the target cluster receives an I/O command issued from an application through a network.

6. The storage system according to claim 5,
wherein each of the plurality of clusters includes one or more volumes, and
wherein in the case where the target cluster has a target volume that is a volume having I/O characteristics that do not conform to the I/O characteristics of the target cluster, the target volume is migrated from the target cluster to a cluster having I/O characteristics conforming to the I/O characteristics of the target volume.

7. The storage system according to claim 1,
wherein the I/O characteristics of the one or more storage nodes are based on an application definition indicated by information input through a user interface, and
wherein the application definition is a definition related to one or more applications issuing an I/O command to the one or more storage nodes, and includes the class of at least one application among the one or more applications.

8. The storage system according to claim 1,
wherein each of the plurality of storage nodes includes a monitoring unit monitoring I/O statistics that are statistics on the basis of the write quantity and the read quantity of the storage node,
wherein the I/O characteristics of the one or more storage nodes include the I/O statistics of the one or more storage nodes identified on the basis of the I/O statistics of each of the one or more storage nodes, and
wherein every time resource allocation is decided on the basis of the I/O characteristics of the one or more storage nodes, if the decided resource allocation differs from recent resource allocation of the one or more storage nodes in each of the one or more storage nodes, the resource quantity allocated to each of the hardware control unit and the command control unit is changed in accordance with the decided resource allocation.

9. The storage system according to claim 1,
wherein the I/O characteristics of the one or more storage nodes include a configuration class compliant with whether or not the one or more storage nodes receive an I/O command issued from an application through a network.

10. The storage system according to claim 1,
wherein each of the one or more storage nodes includes one or more volumes, and
wherein in the case where the one or more storage nodes have a target volume that is a volume having I/O characteristics that do not conform to the I/O characteristics of the one or more storage nodes, the target volume is migrated from the one or more storage nodes to one or more storage nodes having I/O characteristics conforming to the I/O characteristics of the target volume.

11. The storage system according to claim 1,
wherein a decision on the resource allocation is to select an operation mode conforming to the I/O characteristics of the one or more storage nodes from a plurality of operation modes related to an input and output,
wherein for each of the plurality of operation modes, resource allocation compliant with the operation mode is associated with the operation mode, and
wherein for each of the one or more storage nodes, the decided resource allocation is resource allocation associated with the selected operation mode.

12. A resource allocation control method, comprising:
identifying I/O characteristics of one or more storage nodes of a node group including a plurality of storage nodes,
wherein each of the plurality of storage nodes includes:
a resource group as a plurality of computation resources including one or more processor devices, one or more storage devices, and one or more communication interface devices;
a hardware control unit that includes one or more drivers controlling the one or more permanent storage devices and the one or more communication interface devices; and
a command control unit that, in the case where the storage node receives an I/O (Input/Output) command, controls the hardware control unit in an I/O process in accordance with the I/O command;
deciding resource allocation to the hardware control unit and the command control unit in each of the one or more storage nodes for the one or more storage nodes, on the basis of the identified I/O characteristics; and
allowing, of the resource quantity of the resource group of the storage node, a resource quantity allocated to each of the hardware control unit and the command control unit to comply with the decided resource allocation in each of the one or more storage nodes.
